(19) United States
(12) Patent Application Publication
(10) Pub. No.: US 2002/0163541 A1
(43) Pub. Date: Nov. 7, 2002

(54) System and method for organizing and presenting information relating to the interpretation of multiple information elements, such as patent claim elements, in at least one reference source and graphical user interface incorporating the same

(76) Inventor: G. Thomas Williams, Grand Rapids, MI (US)

Correspondence Address: MCGARRY BAIR LLP, 171 MONROE AVENUE, SUITE 600, GRAND RAPIDS, MI, 49503, US

(21) Appl. No.: 09/681,593

(22) Filed: May 3, 2001

Related U.S. Application Data
(60) Provisional application No. 60/201,917, filed on May 4, 2000.

(51) Int. Cl. G06F 3/00

(52) U.S. Cl. 345/764; 345/866

(57) ABSTRACT

A system, a method and a graphical interface are provided for organizing information relating to the interpretation of multiple information elements from at least one reference source. A matrix having a first predetermined number of rows and a second predetermined number of columns defining matrix elements at the intersections of the rows and columns. Each of the first predetermined number of rows or columns of the matrix correspond to an information element and each of the second predetermined number of columns or rows correspond to the at least one reference source. A location in the at least one reference source corresponding to the interpretation of a particular information element can thereby be found at the matrix element at the intersection in the matrix of the row corresponding to the information element to be interpreted and the column corresponding to the at least one reference source.

### CROSS REFERENCE TO RELATED APPLICATIONS

This application claims the benefit of U.S. Provisional Application No. 60/201,917, filed May 4, 2000.

### BACKGROUND OF INVENTION

1. Field of the Invention

The invention relates to a system and method for locating information relating to the interpretation of multiple elements, such as patent claim elements, in a plurality of reference sources. In one aspect, the invention relates to the construction of an information matrix that corresponds to links and/or locations to information from a plurality of reference sources, such as a patent specification, claims, drawings, prior art and a prosecution history, assisting in the interpretation of patent claim elements. In another aspect, the invention relates to a user interface for presenting this information in an easily understandable form.

2. Description of the Related Art

Patents are generally comprised of a textual description of an invention (usually referred to as the specification), drawings, and at least one numbered sentence referred to as a claim. The prosecution history represents the history of the transactions between an applicant and a national patent office. Prior art is referred to as various publicly available reference sources usually in the form of printed publications, usually issued patents or published patent applications, describing the developments in the area of technology to which the invention relates. The claims of a patent define the intellectual property bounds of an invention and are typically made up of sub-components often referred to as claim elements.

To determine whether a device, article, process, or composition of matter that is made, used, sold or offered for sale comes within the scope of a patent claim, and thus infringes the patent, the elements of that claim must be interpreted to determine its proper legal scope. In the United States, the interpretation of patent claims is the province of the judge rather than a jury as a result of the decision in Markman v. Westview Instruments, Inc. 52 F.3d 967, 34 USPQ2d 1321 (Fed. Cir. 1995) (en banc), aff'd, 517 US 370, 116 S. Ct. 1384, 134 L. Ed. 2d 577 (1996) (hereinafter referred to as Markman). The Markman decision mandates that each of the elements of a patent claim be interpreted by the judge in a patent infringement case. This interpretation must be made with respect to a set of predetermined reference sources typically the patent's claims, textual description, drawings, prior art and its prosecution history (referred to as “intrinsic” evidence). In limited cases, other “extrinsic” evidence such as the testimony of expert witnesses can be employed to assist the judge in understanding the intrinsic evidence.

The determination of the legal scope of a patent's claims is not an easy process. The number of documents to review and understand is large. The topics are often complex and require a great deal of organization by counsel for each party to effectively and efficiency present their case to the judge. Difficulties have arisen in reducing the often voluminous amount of information from multiple sources of reference into a short, informative, and effective presentation regarding the scope of the claim.

### SUMMARY OF INVENTION

The invention overcomes these limitations by providing a simple and efficient system and method of preparing a presentation regarding the scope of a patent's claims. In one aspect, the invention contemplates the construction of a rectangular matrix with row elements corresponding to the elements to be interpreted and column elements corresponding to the reference sources from which the information to interpret each row element is to be obtained. The coordinate intersections between each of the row and column elements in the matrix corresponds to a link and/or location within the corresponding column reference source to interpret the corresponding row element. In one embodiment, the row elements are patent claims and the column elements comprise a group consisting of the patent's textual description, its drawings, prior art patents and its prosecution history.

In another embodiment, the invention relates to a method for interpreting multiple row elements from a plurality of reference sources. In an additional embodiment, the invention relates to a graphical user interface for performing the interpretation and simply and effectively presenting the interpretation of the row elements to an audience.

In one aspect of the invention, the invention relates to a method for organizing information relating to the interpretation of multiple information elements from at least one reference source comprising the steps of: forming a matrix having a first predetermined number of rows and a second predetermined number of columns defining matrix elements at the intersections of the rows and columns, wherein each of one the first predetermined number of rows and the second predetermined number of columns of the matrix correspond to an information element and each of the other of the first predetermined number of rows and the second predetermined number of columns correspond to the at least one reference source; determining a reference location within the at least one reference source relating to the interpretation of an information element and setting the reference location to null if no information relating to the interpretation of the information element exists in the at least one reference source; inserting the reference location into the matrix element in the matrix corresponding to the particular information element and the particular at least one reference source; and repeating each of the previous two steps for each of the multiple information elements and the at least one reference source. The location in the at least one reference source corresponding to the interpretation of a particular information element can thereby be found at the matrix element at the intersection in the matrix corresponding to the information element to be interpreted and the at least one reference source.

The multiple information elements can comprise patent claim elements. The at least one reference source can comprise at least one item selected from the group consisting of a patent specification, patent claims, patent drawings, a prosecution history and at least one prior art document.

The invention also relates to a graphical user interface incorporating any of the preceding method claims. In another aspect, the invention relates to a graphical user interface for organizing and presenting information relating to the interpretation of multiple information elements from at least one reference source comprising an array having a first predetermined number of rows and a second predetermined number of columns defining matrix elements at the intersections of the rows and columns, wherein each of one of the first predetermined number of rows and the second predetermined number of columns of the matrix correspond to an information element and each of the other of the first predetermined number of rows and the second predetermined number of columns correspond to the at least one reference source. The matrix elements thereby contain a link to a reference location within the at least one reference source relating to the interpretation of an information element and setting the link to null if no information relating to the interpretation of the information element exists in the at least one reference source. A customizable workspace is provided that is viewable by a user wherein the links within the array can be selectively activated and viewed by the user.

The customizable workspace can further comprise a first border, wherein the first border contains headings corresponding to the multiple information elements. The customizable workspace can further comprise a second border, wherein the second border contains headings corresponding to the at least one reference source. A user can display the reference information contained by a particular link in the array by clicking on one of the headings in the first border and one of the headings on the second border, wherein the link corresponding to the array element is thereby activated.

In a further aspect of the invention, a system for organizing information relating to the interpretation of multiple information elements from at least one reference source is provided comprising a matrix having a first predetermined number of rows and a second predetermined number of columns defining matrix elements at the intersections of the rows and columns, wherein each of one of the first predetermined number of rows and the second predetermined number of columns of the matrix correspond to an information element and each of the other of the first predetermined number of rows and the second predetermined number of columns correspond to the at least one reference source. Each of the matrix elements comprises one of a reference location value representative of a location within the at least one reference source relating to the interpretation of the corresponding information element, and a null value if no information relating to the interpretation of the information element exists in the at least one reference source. The location in the at least one reference source corresponding to the interpretation of a particular information element can be found at the matrix element at the intersection in the matrix of the row corresponding to the information element to be interpreted and the column corresponding to the at least one reference source.

The multiple information elements can comprise patent claim elements. The at least one reference source can comprise at least one item selected from the group consisting of a patent specification, patent claims, patent drawings, a prosecution history and at least one prior art document. The system can further comprise a graphical user interface adapted to display at least one of the reference location values stored in the matrix as well as at least one data file representative of the information contained in the at least one reference source. The graphical user interface can comprise a customizable workspace viewable by a user wherein the reference location values within the matrix can be selectively activated and the corresponding information in the corresponding at least on reference source can be viewed by the user. The customizable workspace can further comprise a first border, wherein the first border contains headings corresponding to the multiple information elements. The customizable workspace can further comprise a second border, wherein the second border contains headings corresponding to the at least one reference source. A user can display the reference information contained by a particular link in the array by clicking on one of the headings in the first border and one of the headings on the second border, wherein the link corresponding to the array element is thereby activated. The at least one reference source can comprise at least one item selected from the group consisting of a patent specification, patent claims, patent drawings, a prosecution history and at least one prior art document.

Other objects, features, and advantages of the invention will be apparent from the ensuing description in conjunction with the accompanying drawings.

### BRIEF DESCRIPTION OF DRAWINGS

FIG. 1 is a schematic drawing of a system for locating information relating to the interpretation of multiple elements, such as patent claim elements, in a plurality of reference sources according to the invention comprising a matrix wherein the rows of the matrix comprise the multiple elements to be interpreted and the columns of the matrix comprise each of multiple reference sources which contain information relevant to the interpretation of row elements, and the intersections of each of the rows in columns of the matrix comprise a location of and/or link to information relating to the interpretation of each row element within each column reference source of information.

FIG. 2 is a schematic drawing of FIG. 1 wherein the row elements have been replaced with patent claim elements and the column reference sources have been replaced with the legally-mandated reference sources for interpretation of the patent claim elements of each row in accordance with the Markman decision.

FIG. 3 is a schematic of a graphical user interface depicting an interactive computer software application of the system and method of FIGS. 1-2 wherein a left-hand portion of the user interface contains the patent claim elements relating to the row elements of FIGS. 1-2 and a horizontal tool bar located in an upper portion of the user interface contains the column reference sources of FIGS. 1-2 and the user interface further comprises a customizable workspace adapted to depict information relating to a pre-selected row element (e.g., patent claim element) and column element (e.g., reference source).

FIG. 4 is a flow chart outlining a method for locating information relating to the interpretation of multiple elements, such as patent claim elements, in a plurality of reference sources according to the invention of FIGS. 1-3.

### DETAILED DESCRIPTION

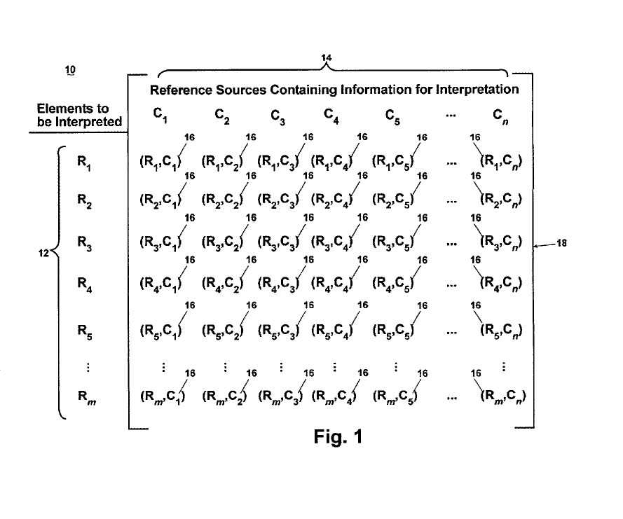

Referring now to the drawings and to FIG. 1 in particular, a system and method for locating information relating to the interpretation of multiple elements, such as patent claim elements, in a plurality of reference sources is shown by reference numeral 10 according to the invention comprising a plurality of row elements 12 and a plurality of column elements 14 wherein intersections therebetween are shown in (row, column) coordinate format and by reference numeral 16. The method and system 10 according to the invention thereby comprises a matrix 18 according to the invention having the row elements 12 (designated as R₁ . . . Rₘ) and the column reference sources 14 (designed as C₁ . . . Cₙ).

The row elements R₁ . . . Rₘ represent information elements which are desired to be interpreted by referencing locations within each of the column elements 14, identified as columns C₁ . . . Cₙ. The intersections 16 identified within the matrix 18 comprises location and/or links of information relating to the interpretation of row elements R₁ . . . Rₘ within the reference sources identified in the column element C₁ . . . Cₙ. In this way, a user can easily locate all elements relating to a particular row element Cⱼ within the multiple reference sources C₁ . . . Cₙ by merely referencing each of the locations and/or links of the intersection 16 of row Rᵢ within the matrix 18.

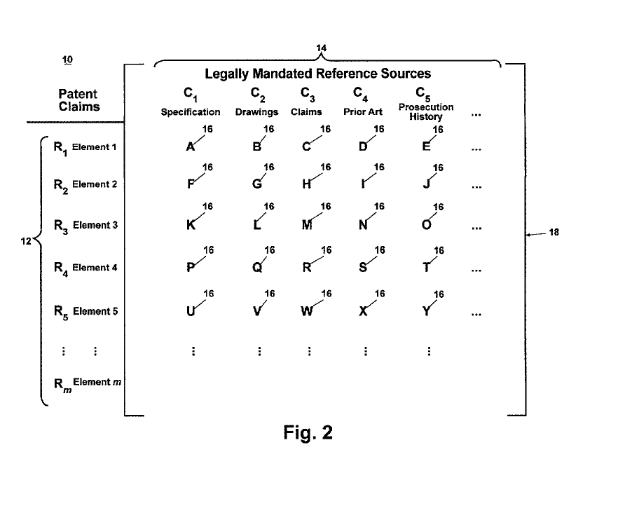

FIG. 2 is a schematic drawing of FIG. 1 wherein the row elements are patent claim elements and the column reference sources are the legally-mandated reference sources for interpretation of the patent claim elements of each row. According to the Markman case referred to in the background section of this application, patent claim elements are interpreted in the United States with respect to the legally-mandated reference sources including the specification (C₁), the patents drawings (C₂), the patent claims (C₃), the known prior art (C₄), and the prosecution history (C₅).

Thus, these elements relating to the interpretation of patent claim elements R₁ . . . Rₘ can be located within the intersections 16 shown by reference letters A-Y. The number of intersections 16 depend upon the number m of patent claim elements and the number n of reference sources mandated for interpretation of the patent claim elements. The intersection 16 corresponding to the location within the reference sources C₁ . . . Cₙ of the legally-mandated reference sources 14 of the matrix 18 can be gathered easily by referencing the intersection 16 of a particular row Rᵢ (where i is 1 . . . m) for all information relating to the interpretation of a particular claim element.

For example, row R of the matrix 18 contains reference numerals A-E which relate to the specific locations within the specification C₁, drawing C₂, claims C₃, prior art C₄, and prosecution history C₅, respectively, of all information relating to the interpretation of claim element R₁. The location shown by the intersection 16 can be links to the information such as a footnote to a particular location within the legally-mandated reference sources C₁ . . . Cₙ, as well as a computer-related link such as hypertext links, animations, text, word processing documents, electronic files and other digital or recorded information on any type of media as long as the reference intersection 16 directs the user of the system 10 to the particular location within the reference sources C₁ . . . Cₙ to interpret each of the patent claim elements R₁ . . . Rₘ.

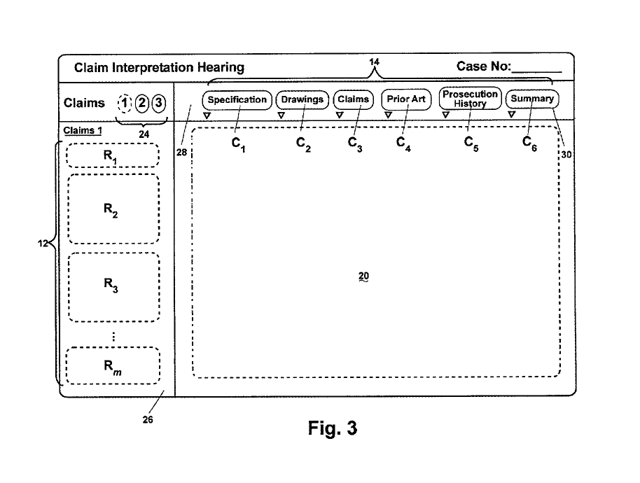

FIG. 3 is a schematic of a user interface depicting an interactive computer software application of the system and method of FIGS. 1-2 wherein a left-hand frame 26 of the user interface contains the patent claim elements R₁ . . . Rₘ relating to the row elements 12 of FIGS. 1-2 and a horizontal tool bar located in an upper portion of the user interface contains the reference sources C₁ through C₆ of the column elements 14 of FIGS. 1-2. The user interface further comprises a customizable workspace 20 comprising a majority of the user interface depicting information relating to a selected row element Rᵢ (where i is 1 . . . m) and column reference source Cⱼ (where j is 1 . . . n).

The customizable workspace 20 can contain any type of visual indicia which can be a series of scripts, executable routines, displays, hypertext links, etc. wherein each of the intersections 16 of the matrix 18 of FIGS. 1-2 directs the interface shown in FIG. 3 to display the information identified in the particular intersection 16 (Rᵢ, Cⱼ) selected in the matrix 17.

In this manner, each of the patent claim elements R₁ . . . Rₘ of a particular claim of a patent can be selected by clicking on a claim identifier 24 on the interface 22 to display a particular set of claim elements R₁ . . . Rₘ in the frame 26 beneath the claim identifiers wherein the particular claim elements R₁ . . . Rₘ of a particular claim are shown therein. In addition, the tool bar 28, shown laterally offset from the claim identifiers 24, extends across an upper portion of the visual interface 22 and contains the legally-mandated reference sources C₁ . . . Cₙ located above the customizable workspace 20.

In use, a user can click a claim identifier 24 to display the patent claim elements R₁ . . . Rₘ within the frame 26 therebeneath wherein a user can thereby click on a particular claim element Rₘ and sequentially click on the tool bar 28 and specifically the elements C₁ . . . Cₙ relating to the legally-mandated different sources to display the information relating to the interpretation of the particular patent claim element within the customizable workspace 20. In this manner, an interpretation of a patent claim can be easily determined in a brief, efficient and effective manner. Further, a summary tab 30 can be provided for displaying multiple portions of the legally-mandated reference sources C₁ . . . Cₙ for a particular claim element Rₘ so that the legal scope of each of the claim elements R₁ . . . Rₘ can be easily determined.

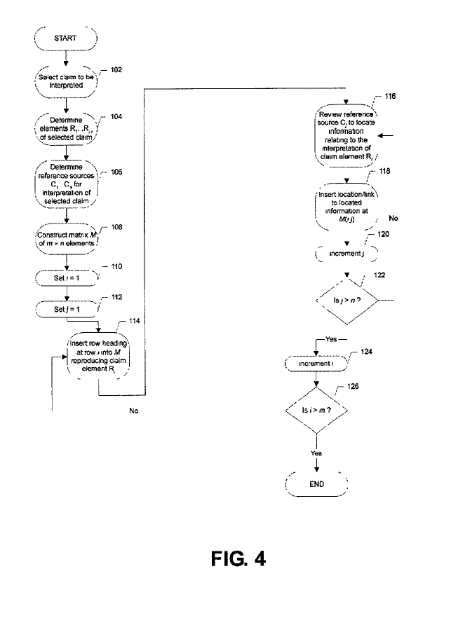

The following describes a method for interpreting multiple elements 12 in accordance with multiple reference sources 14 in accordance with the system described with respect to FIGS. 1-3 and with further reference to FIG. 4. The reference numerals surrounded by less-than (<) and greater-than signs (>) refer to the process steps of FIG. 4, e.g., <102>.

First, a user selects a claim to be interpreted <102> of a patent at issue. The user then determines the sub-components or elements R₁ . . . Rₘ of the selected claim <104>. It will be understood that this process can be repeated as many times as necessary depending upon the number of patent claims to be interpreted.

Next, the user determines the appropriate reference sources 14 (shown in FIGS. 1-3 by identifier C₁ . . . Cₙ) for interpretation of the elements 12 (shown in FIGS. 1-3 by identifier R₁ . . . Rₘ) of the selected claim <106>.

Then, a user constructs a matrix M of m×n elements <108>. Thus matrix M can be formed on paper, within software such as a database or spreadsheet, in presentation or animation software, etc., without departing from the scope of this invention.

Counters are then set to parse through the matrix M and fill the elements 16 of the matrix M with links and/or location of information in the reference sources C₁ . . . Cₙ of each of the row elements R₁ . . . Rₘ. These counters are initially set to a value of 1 and referred to as i and j<110>, <112> for the purposes of illustration. For each element Rᵢ, a row heading is provided to the matrix M at row i which preferably reproduces the claim element Rᵢ<114>.

Each reference source Cⱼ is reviewed to locate information relating to the interpretation of claim element Rᵢ<116>. Information representing the location of or a link to the located information is inserted into the matrix M at M(i, j)<118>. Counter j is incremented <120>. If counter j is greater than n (the number of reference sources), processing jumps to reference step <124>. If j is less than or equal to n<122>, processing returns to step <116> to repeat steps <116> through <120> for the remaining reference sources C₁ . . . Cₙ for row element Rᵢ. The matrix element M(i, j) is set to a null value if no information is found in reference source Cⱼ relative to the interpretation of row element Rᵢ.

Once processing jumps to <124>, counter i is incremented. Counter i is checked to determine whether it is greater than m<126>. If not, processing returns to <114> to continue with the next row element Rᵢ. If i is greater than m, processing ends and the matrix M is ready for presentation with a graphical user interface such as that shown in FIG. 3.

While the invention has been specifically described in connection with certain specific embodiments thereof, it is to be understood that this is by way of illustration and not of limitation, and the scope of the appended claims should be construed as broadly as the prior art will permit.

1. a method for organizing information relating to the interpretation of multiple information elements from at least one reference source comprising:
(1) forming a matrix having a first predetermined number of rows and a second predetermined number of columns defining matrix elements at the intersections of the rows and columns, wherein each of one the first predetermined number of rows and the second predetermined number of columns of the matrix correspond to an information element and each of the other of the first predetermined number of rows and the second predetermined number of columns correspond to the at least one reference source;
(2) determining a reference location within the at least one reference source relating to the interpretation of an information element and setting the reference location to null if no information relating to the interpretation of the information element exists in the at least one reference source;
(3) inserting the reference location into the matrix element in the matrix corresponding to the particular information element and the particular at least one reference source; and
(4) repeating each of steps (2) and (3) for each of the multiple information elements and the at least one reference source;
whereby the location in the at least one reference source corresponding to the interpretation of a particular information element can be found at the matrix element at the intersection in the matrix corresponding to the information element to be interpreted and the at least one reference source.

2. The method of claim 1 wherein the multiple information elements comprise patent claim elements.

3. The method of claim 2 wherein the at least one reference source comprises at least one item selected from the group consisting of a patent specification, patent claims, patent drawings, a prosecution history and at least one prior art document.

4. A graphical user interface incorporating any of the preceding method claims.

5. A graphical user interface for organizing and presenting information relating to the interpretation of multiple information elements from at least one reference source comprising:
an array having a first predetermined number of rows and a second predetermined number of columns defining matrix elements at the intersections of the rows and columns, wherein each of one of the first predetermined number of rows and the second predetermined number of columns of the matrix correspond to an information element and each of the other of the first predetermined number of rows and the second predetermined number of columns correspond to the at least one reference source, and wherein the matrix elements contain a link to a reference location within the at least one reference source relating to the interpretation of an information element and setting the link to null if no information relating to the interpretation of the information element exists in the at least one reference source; and
a customizable workspace viewable by a user wherein the links within the array can be selectively activated and viewed by the user.

6. The graphical user interface of claim 5 wherein the customizable workspace further comprises a first border, wherein the first border contains headings corresponding to the multiple information elements.

7. The graphical user interface of claim 6 wherein the customizable workspace further comprises a second border, wherein the second border contains headings corresponding to the at least one reference source.

8. The graphical user interface of claim 7 wherein a user can display the reference information contained by a particular link in the array by clicking on one of the headings in the first border and one of the headings on the second border, wherein the link corresponding to the array element is thereby activated.

9. A system for organizing information relating to the interpretation of multiple information elements from at least one reference source comprising:
a matrix having a first predetermined number of rows and a second predetermined number of columns defining matrix elements at the intersections of the rows and columns, wherein each of one of the first predetermined number of rows and the second predetermined number of columns of the matrix correspond to an information element and each of the other of the first predetermined number of rows and the second predetermined number of columns correspond to the at least one reference source; and
wherein each of the matrix elements comprises one of:
a reference location value representative of a location within the at least one reference source relating to the interpretation of the corresponding information element; and
a null value if no information relating to the interpretation of the information element exists in the at least one reference source;
whereby the location in the at least one reference source corresponding to the interpretation of a particular information element can be found at the matrix element at the intersection in the matrix of the row corresponding to the information element to be interpreted and the column corresponding to the at least one reference source.

10. The system of claim 9 wherein the multiple information elements comprise patent claim elements.

11. The system of claim 10 wherein the at least one reference source comprises at least one item selected from the group consisting of a patent specification, patent claims, patent drawings, a prosecution history and at least one prior art document.

12. The system of claim 9 and further comprising a graphical user interface adapted to display at least one of the reference location values stored in the matrix.

13. The system of claim 12 and further comprising at least one data file representative of the information contained in the at least one reference source.

14. The system of claim 13 wherein the graphical user interface comprises a customizable workspace viewable by a user wherein the reference location values within the matrix can be selectively activated and the corresponding information in the corresponding at least on reference source can be viewed by the user.

15. The system of claim 14 wherein the customizable workspace further comprises a first border, wherein the first border contains headings corresponding to the multiple information elements.

16. The system of claim 15 wherein the customizable workspace further comprises a second border, wherein the second border contains headings corresponding to the at least one reference source.

17. The system of claim 16 wherein a user can display the reference information contained by a particular link in the array by clicking on one of the headings in the first border and one of the headings on the second border, wherein the link corresponding to the array element is thereby activated.

18. The system of claim 9 wherein the at least one reference source comprises at least one item selected from the group consisting of a patent specification, patent claims, patent drawings, a prosecution history and at least one prior art document.

19. The system of claim 9 and further comprising at least one data file representative of the information contained in the at least one reference source.

20. The system of claim 9 and further comprising a graphical user interface having a customizable workspace viewable by a user wherein the reference location values within the matrix can be selectively activated and the corresponding information in the corresponding at least on reference source can be viewed by the user.

21. The system of claim 20 wherein the customizable workspace further comprises a first border, wherein the first border contains links corresponding to the multiple information elements.

22. The system of claim 21 wherein the customizable workspace further comprises a second border, wherein the second border contains links corresponding to the at least one reference source.

23. The system of claim 22 wherein a user can display the reference information contained by a particular link in the matrix by clicking on one of the link in the first border and one of the headings on the second border, wherein the link corresponding to the matrix element is thereby activated.
